(19) United States
(12) Patent Application Publication
(10) Pub. No.: US 2025/0205858 A1
(43) Pub. Date: Jun. 26, 2025

(54) MECHANICAL CLUTCH IN AN IMPACT TOOL

(71) Applicant: MILWAUKEE ELECTRIC TOOL CORPORATION, Brookfield, WI (US)

(72) Inventors: Joseph T. Lottes-Paukner, Sussex, WI (US); Benjamin J. Skelton, Milwaukee, WI (US)

(21) Appl. No.: 18/999,774

(22) Filed: Dec. 23, 2024

Related U.S. Application Data
(60) Provisional application No. 63/613,300, filed on Dec. 21, 2023.

(51) Int. Cl. B25B 21/02; B25D 16/00

(52) U.S. Cl. CPC B25B 21/026; B25D 16/003

(57) ABSTRACT

An impact tool including a housing, a drive assembly supported within the housing, the drive assembly including a hammer and an anvil configured to receive periodic rotational impacts from the hammer, an output shaft extending from the housing, the output shaft rotatable about an axis in a first direction and a second direction opposite the first direction, and a clutch assembly coupled between the drive assembly and the output shaft. The clutch assembly is configured to couple the output shaft for co-rotation with the anvil in the first direction and to selectively limit torque transfer from the anvil to the output shaft in the second direction.

### CROSS-REFERENCE TO RELATED APPLICATIONS

The present application claims priority to U.S. Provisional Application No. 63/613,300, filed Dec. 21, 2023, the entire contents of which are incorporated by reference herein.

### FIELD

The present disclosure relates to impact tools, and, more particularly, to clutches for impact tools.

### BACKGROUND

Some power tools, specifically rotary power tools, may include a clutch assembly for limiting an amount of torque transferred by the power tool to a workpiece. These tools typically include a clutch-setting selector to allow an operator to select different torque limits.

Rotary impact tools are typically utilized to provide a striking rotational force, or intermittent applications of torque, to a tool element or workpiece (e.g., a fastener) to either tighten or loosen the fastener.

### SUMMARY

In some aspects, the techniques described herein relate to an impact tool including: a housing; a drive assembly supported within the housing, the drive assembly including a hammer and an anvil configured to receive periodic rotational impacts from the hammer; an output shaft extending from the housing, the output shaft rotatable about an axis in a first direction and a second direction opposite the first direction; and a clutch assembly coupled between the drive assembly and the output shaft, wherein the clutch assembly is configured to couple the output shaft for co-rotation with the anvil in the first direction and to selectively limit torque transfer from the anvil to the output shaft in the second direction.

In some aspects, the techniques described herein relate to an impact tool including: a housing; a drive assembly supported within the housing, the drive assembly including a hammer and an anvil configured to receive periodic rotational impacts from the hammer; an output shaft extending from the housing, the output shaft rotatable about an axis in a first direction and a second direction opposite the first direction; and a clutch assembly coupled between the drive assembly and the output shaft, the clutch assembly operable to limit a torque transfer from the drive assembly to the output shaft to a first set torque limit in the first direction, and to limit the torque transfer from the drive assembly to the output shaft to a second set torque limit in the second direction, wherein the second set torque limit is different than the first set torque limit, and wherein the clutch assembly includes a first clutch member rotationally locked with the anvil, and a second clutch member rotationally locked with the output shaft.

In some aspects, the techniques described herein relate to an impact tool including: a housing; a drive assembly supported within the housing, the drive assembly including a hammer and an anvil configured to receive periodic rotational impacts from the hammer; an output shaft extending from the housing, the output shaft rotatable about an axis in a first direction and a second direction opposite the first direction; and a clutch assembly coupled between the drive assembly and the output shaft, the clutch assembly including, a first clutch member coupled for co-rotation with the anvil, the first clutch member including a plurality of first clutch lugs, and a second clutch member coupled for co-rotation with the output shaft, the second clutch member including a plurality of second clutch lugs, wherein the plurality of first clutch lugs and the plurality of second clutch lugs oppose and engage one another when the output shaft rotates in the first direction.

Other features and aspects of the disclosure will become apparent by consideration of the following detailed description and accompanying drawings.

### BRIEF DESCRIPTION OF THE DRAWINGS

FIG. 1 is a perspective view of an exemplary power tool in which a clutch assembly embodying aspects of the present disclosure may be implemented.

FIG. 2 is a perspective view of a drive assembly of the rotary power tool of FIG. 1.

FIG. 3 is a cross-sectional view of the drive assembly of FIG. 2.

FIG. 4A is an isolated view of an anvil, a clutch assembly, and an output shaft of the power tool of FIG. 1.

FIG. 4B is a side perspective view of the anvil, the clutch assembly, and the output shaft of the power tool of FIG. 4A.

FIG. 5 is a perspective view of the anvil, the clutch assembly, and the output shaft of the power tool of FIG. 1 with a spring hidden.

FIG. 6 is a side view illustrating operation of the clutch assembly in a loosening direction.

FIG. 7 is a side view illustrating operation of the clutch assembly in a tightening direction.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

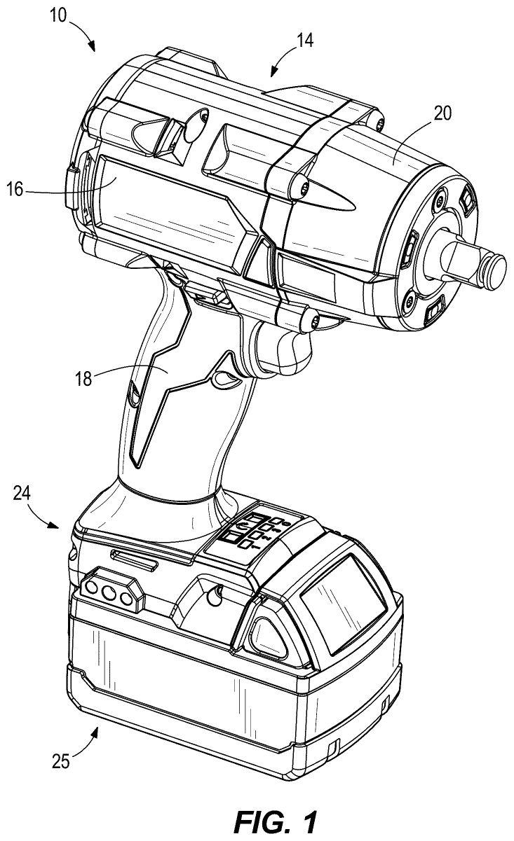

FIG. 1 illustrates a power tool 10, and more specifically, a rotary impact tool in the form of an impact wrench. The power tool 10 includes a housing 14 having a motor housing portion 16, a handle portion 18 extending from the motor housing portion 16, and a front housing portion 20 or gear case coupled to a front side of the motor housing portion 16. A battery receptacle 24 is located at the bottom end of the handle portion 18 and is configured to receive a battery 25 (e.g., a rechargeable power tool battery pack). The illustrated power tool 10 is configured as a T-handle or pistol-grip style power tool; however, the power tool 10 may be configured differently in other embodiments. For example, in other embodiments, the handle portion 18 may extend rearwardly from the motor housing portion 16 and form a generally D-shaped handle. Additionally, in some embodiments, the front housing portion 20 may be integrally formed as a single piece with the motor housing portion 16.

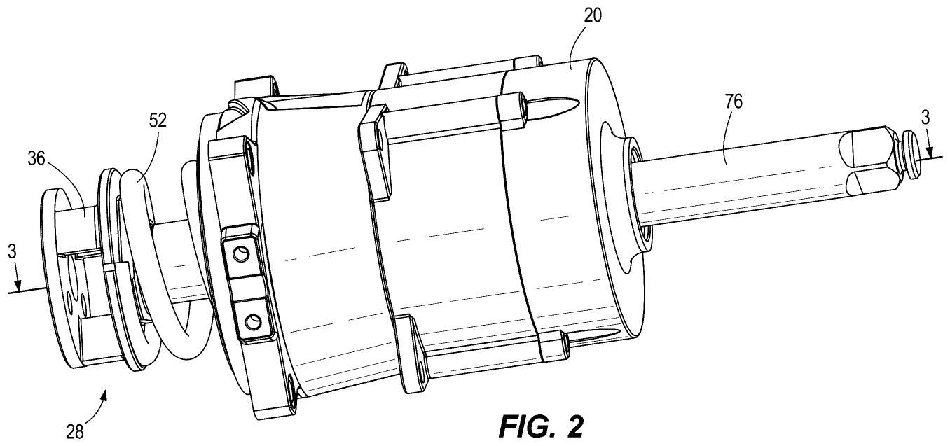

An electric motor (not shown) is disposed within the housing 14 and is supported within the motor housing portion 16. The motor transmits torque to a drive assembly 28, which generates and transmits periodic rotational impacts (i.e., incremental application of torque) to an output shaft 76 (FIG. 2). The output shaft 76 extends from the front housing portion 20 and is configured to receive a tool bit (e.g., a socket, etc.) for performing work (e.g., tightening or loosening) on a workpiece (e.g., a fastener).

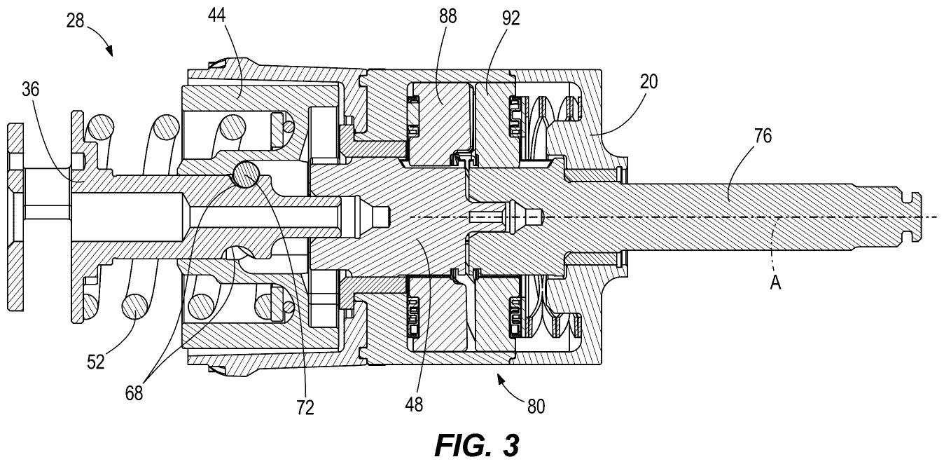

Referring to FIG. 3, the drive assembly 28 includes a transmission (e.g., a planetary transmission; not shown) coupled to the electric motor and a camshaft 36 driven by an output of the transmission. In some embodiments, the camshaft 36 may form a planet carrier of the planetary transmission. The drive assembly 28 also includes a hammer 44 and an anvil 48. The hammer 44 is configured to strike the anvil 48 to impart torque on the anvil 48. The drive assembly 28 is configured to convert the constant rotational force or torque provided by the transmission to a striking rotational force or intermittent applications of torque and impart the torque to the anvil 48 when the reaction torque on the anvil 48 (e.g., due to engagement between the tool and a fastener being worked upon) exceeds a certain threshold. Stated another way, the hammer 44 is configured to reciprocate axially along the camshaft 36 and rotate relative to the camshaft 36 to impart rotational impacts to the anvil 48.

The drive assembly 28 further includes a spring 52 biasing the hammer 44 toward the front of the power tool 10 (e.g., in the right direction of FIGS. 2 and 3). In other words, the spring 52 biases the hammer 44 in an axial direction toward the anvil 48. The camshaft 36 includes cam grooves 68 in which corresponding cam balls 72 are received. The cam balls 72 are in driving engagement with the hammer 44 and movement of the cam balls 72 within the cam grooves 68 allows for relative axial movement of the hammer 44 along the camshaft 36 when the hammer 44 lugs and the anvil 48 lugs are engaged and the camshaft 36 continues to rotate.

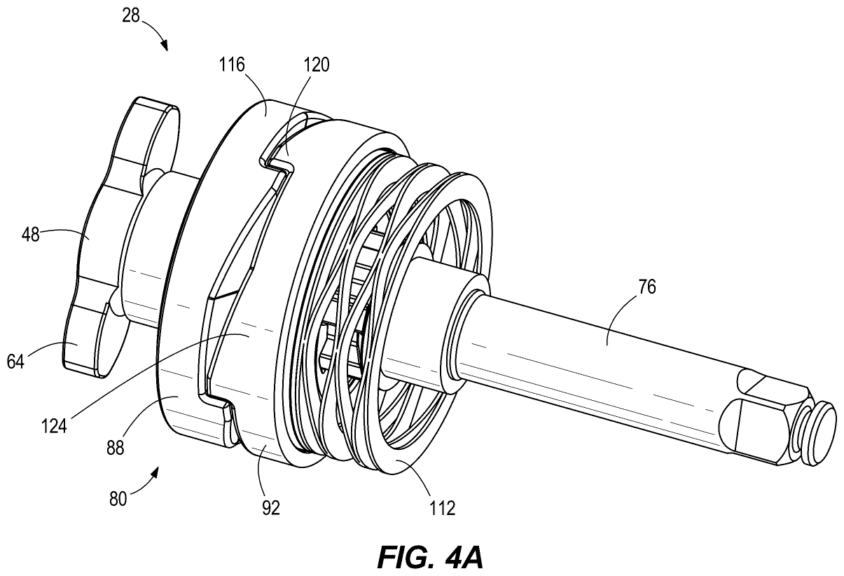

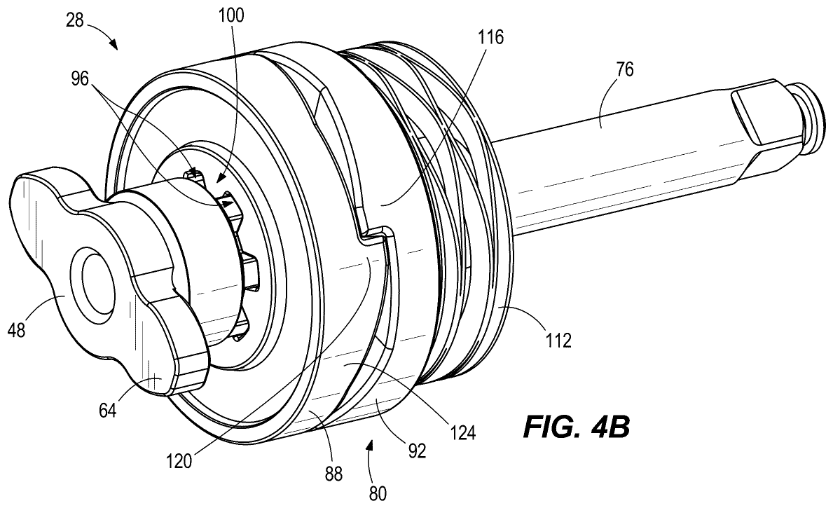

Referring to FIGS. 3-4B, a clutch assembly 80 is coupled between the drive assembly 28 and the output shaft 76, such that torque may be transferred from the drive assembly 28 to the output shaft 76 through the clutch assembly 80 to rotate the output shaft 76. The clutch assembly 80 selectively limits the torque transfer from the drive assembly 28 to the output shaft 76. In the illustrated embodiment, the clutch assembly 80 is operable to limit the torque transfer from the drive assembly 28 to the output shaft 76 to a first set torque limit in a first rotational direction (e.g., a tightening direction), and to limit the torque transfer from the drive assembly 28 to the output shaft 76 to a second set torque limit (e.g., greater than the first set torque limit) or to not limit the torque transfer from the drive assembly 28 to the output shaft 76 in a second, opposite rotational direction (e.g., a loosening direction). In this way, the clutch assembly 80 may prevent over-tightening of a fastener but may allow a greater torque output of the power tool 10 to be available to loosen an over-tightened fastener or break free a stuck fastener.

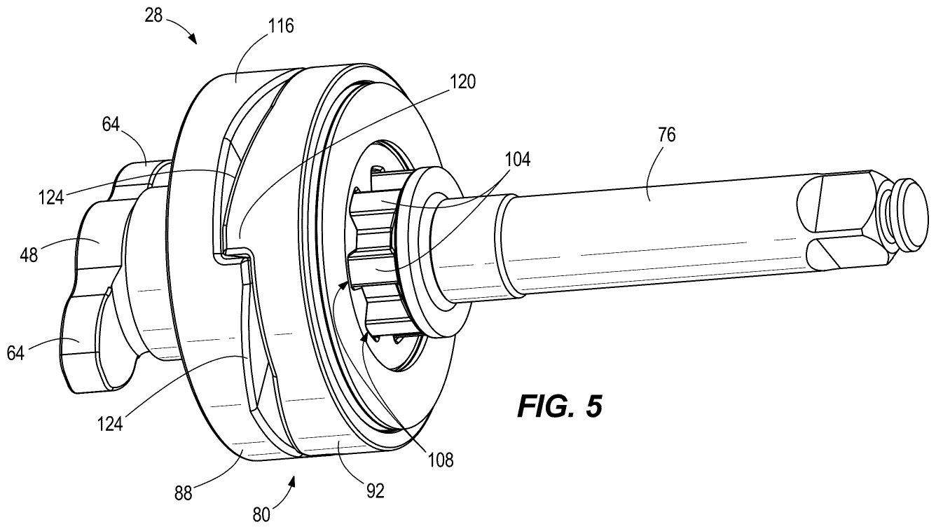

Referring to FIGS. 4A-5, the illustrated clutch assembly 80 includes a first clutch member 88 rotationally locked (i.e. coupled for co-rotation) with the anvil 48 and a second clutch member 92 rotationally locked with the output shaft 76. As described in greater detail below, the second clutch member 92 is slidable along the output shaft 76 when the clutch assembly 80 slips due to torque exceeding the torque setting of the clutch assembly 80. The anvil 48 and first clutch member 88 are rotationally locked via a plurality of protrusions 96 received within a corresponding plurality of first clutch recesses 100. Similarly, the output shaft 76 and the second clutch member 92 are rotationally locked via a plurality of output shaft protrusions 104 received in a corresponding plurality of second clutch recesses 108. In other embodiments, the first clutch member 88 and the anvil 48, and/or the second clutch member 92 and the output shaft 76, may be rotationally locked together in other ways (e.g., via D-shaped geometries, spline patterns, or the like). In yet other embodiments, the anvil 48 and the first clutch member 88 may be integrally formed together as a single piece.

Referring to FIGS. 4A-4B, the first clutch member 88 opposes the second clutch member 92 which is biased into engagement with the first clutch member 88 by a spring 112. In the illustrated embodiment, the spring 112 is a wave spring, which surrounds the output shaft 76 and biases the second clutch member 92 toward the first clutch member 88. Due to the geometry of the wave spring 112, the wave spring 112 provides a flat, stable, and compact configuration when fully compressed. In other embodiments, the spring 112 may be one or more coil springs, one or more disc springs, or the like, for biasing the second clutch member 92 toward the first clutch member 88.

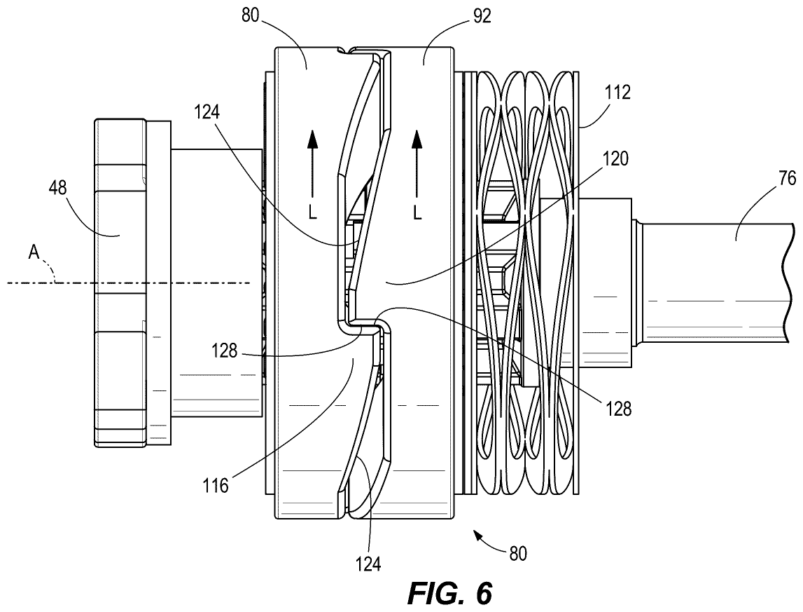

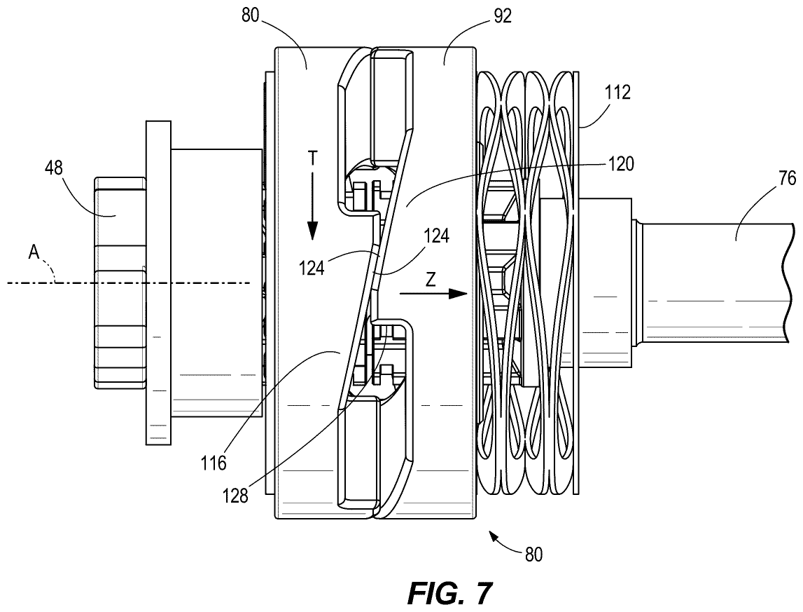

Best illustrated in FIGS. 6-7, the first clutch member 88 includes a plurality of first clutch lugs 116 and the second clutch member 92 includes a plurality of second clutch lugs 120. The first clutch member 88 and the second clutch member 92 may each include four clutch lugs 116, 120 in some embodiments, equally spaced apart in 90-degree increments. In other embodiments, the first clutch member 88 and the second clutch member 92 may include other numbers and configurations of clutch lugs 116, 120.

The first clutch lugs 116 and the second clutch lugs 120 are biased into engagement by the spring 112. The first clutch lugs 116 and the second clutch lugs 120 each include a ramped surface 124, oriented at an oblique angle (e.g., between 15 and 60 degrees) relative to a rotational axis A of the output shaft 76, and a step surface 128, extending parallel to the rotational axis A. The step surfaces 128 of the respective first clutch lugs 116 and second clutch lugs 120 oppose and engage one another when the anvil 48 is driven in the loosening direction L (FIG. 6). The engagement of the step surfaces 128 couples the second clutch member 92 for co-rotation with the first clutch member 88 in the loosening direction L without limiting torque transfer. Alternatively, as mentioned above, the step surfaces 128 may be oriented at a second, different oblique angle (e.g., between 70 degrees and 85 degrees) relative to the rotational axis A of the output shaft 76, such that the clutch assembly 80 is operable to limit the output torque to different limits depending on whether the power tool 10 is operated in a forward or reverse direction.

In some embodiments, the first clutch lugs 116 and/or the second clutch lugs 120 may be dovetailed at an end to prevent the first clutch member 88 and the second clutch member 92 from separating during reverse rotation. In contrast, when the anvil 48 is driven in the tightening direction T (FIG. 7), the ramped surfaces 124 engage one another. When the power tool 10 is applying torque through the output shaft 76 below the torque setting of the clutch assembly 80, the friction between the ramped surfaces 124 as well as a tangential component of the normal force applied by the spring 112 are sufficient to couple the second clutch member 92 for co-rotation with the first clutch member 88 in the tightening direction T. However, if the resistance on the output shaft 76 exceeds the torque setting of the clutch assembly 80, the torque from the anvil 48 is sufficient to overcome the friction and normal force between the ramped surfaces 124, and the first clutch member 88 may begin to rotate in the tightening direction T relative to the second clutch member 92. The engagement of the opposing ramped surfaces 124 causes the second clutch member 92 to translate away from the first clutch member 88 along the axis A, in the direction of arrow Z in FIG. 7, against the biasing force of the spring 112. This process may continue if the power tool 10 continues to operate, such that the clutch assembly 80 allows the anvil 48 and the first clutch member 88 to rotate while the second clutch member 92 and the output shaft 76 remain stationary.

In some embodiments, the spring 112 may have an adjustable preload (e.g., by a rotatable collar on the outside of the gearcase) to allow for the output torque to be adjusted. The clutch assembly 80 may further include an adjustment mechanism to allow a user to vary the upper torque limit that is transmitted by the clutch prior to slipping. The adjustment mechanism may include an outer collar and an inner sleeve. The outer collar may be axially fixed relative to the gear case 20 and rotatable relative to the gear case 20 about the axis A. The inner sleeve may be coupled for co-rotation with the outer collar may be axially movable relative to the outer collar. The inner sleeve may have an annular recess in its rear side which may receive an end of the wave spring 112.

The inner sleeve and the gear case 20 may have threads engaged such that rotation of the outer collar and the inner sleeve relative to the gear case 20 results in axial motion of the inner sleeve along the gear case 20. Thus, rotation of the collar in a first direction to move the inner sleeve axially rearwards (towards the motor) may compress the wave spring 112, thereby increasing the force applied onto first clutch member 88 and the second clutch member 92. Likewise, rotation of the collar in a second, opposite direction to move the inner sleeve axially forward (away from the motor) may reduce the preload on the wave spring 112. In some embodiments, rotation of the collar in the first direction may decouple the clutch assembly 80 such that the anvil 48 is directly coupled to the output shaft 76. In some embodiments, the outer collar may include a detent mechanism and/or indicia to provide tactile and/or visual indications to a user of the amount of adjustment or torque setting applied to the clutch assembly 80.

Although the disclosure has been described in detail with reference to certain preferred embodiments, variations and modifications exist within the scope and spirit of one or more independent aspects of the disclosure as described.

Various features and aspects of the present disclosure are set forth in the following claims.

What is claimed is:

1. An impact tool comprising:
a housing;
a drive assembly supported within the housing, the drive assembly including a hammer and an anvil configured to receive periodic rotational impacts from the hammer;
an output shaft extending from the housing, the output shaft rotatable about an axis in a first direction and a second direction opposite the first direction; and
a clutch assembly coupled between the drive assembly and the output shaft, wherein the clutch assembly is configured to couple the output shaft for co-rotation with the anvil in the first direction and to selectively limit torque transfer from the anvil to the output shaft in the second direction.

2. The impact tool of claim 1, wherein the clutch assembly includes,
a first clutch member coupled for co-rotation with the anvil,
a second clutch member opposite the first clutch member, the second clutch member coupled for co-rotation with the output shaft, and
a spring configured to bias the second clutch member into engagement with the first clutch member.

3. The impact tool of claim 2, wherein a torque setting is adjustable by varying a preload on the spring.

4. The impact tool of claim 2, wherein the spring is a wave spring.

5. The impact tool of claim 1, wherein the impact tool is operable to rotate a fastener in a tightening direction and a loosening direction, wherein the first direction corresponds to the loosening direction, and wherein the second direction corresponds to the tightening direction.

6. An impact tool comprising:
a housing;
a drive assembly supported within the housing, the drive assembly including a hammer and an anvil configured to receive periodic rotational impacts from the hammer;
an output shaft extending from the housing, the output shaft rotatable about an axis in a first direction and a second direction opposite the first direction; and
a clutch assembly coupled between the drive assembly and the output shaft, the clutch assembly operable to limit a torque transfer from the drive assembly to the output shaft to a first set torque limit in the first direction, and to limit the torque transfer from the drive assembly to the output shaft to a second set torque limit in the second direction,
wherein the second set torque limit is different than the first set torque limit, and
wherein the clutch assembly includes a first clutch member rotationally locked with the anvil, and a second clutch member rotationally locked with the output shaft.

7. The impact tool of claim 6, wherein the first direction is a tightening direction.

8. The impact tool of claim 7, wherein the second direction is a loosening direction.

9. The impact tool of claim 6, wherein the second set torque limit is greater than the first set torque limit.

10. The impact tool of claim 6, wherein the second clutch member is slidable along the output shaft when the clutch assembly slips due to torque exceeding the first set torque limit of the clutch assembly.

11. The impact tool of claim 6, wherein the anvil and the first clutch member are rotationally locked via a plurality of protrusions received within a corresponding plurality of first clutch recesses, wherein the plurality of protrusions is positioned on the anvil and the plurality of first clutch recesses is arranged on the first clutch member.

12. The impact tool of claim 11, wherein the output shaft and the second clutch member are rotationally locked via a plurality of output shaft protrusions received in a corresponding plurality of second clutch recesses, wherein the plurality of output shaft protrusions is positioned on the output shaft and the plurality of second clutch recesses is arranged on the second clutch member.

13. An impact tool comprising:
a housing;
a drive assembly supported within the housing, the drive assembly including a hammer and an anvil configured to receive periodic rotational impacts from the hammer;
an output shaft extending from the housing, the output shaft rotatable about an axis in a first direction and a second direction opposite the first direction; and
a clutch assembly coupled between the drive assembly and the output shaft, the clutch assembly including,
a first clutch member coupled for co-rotation with the anvil, the first clutch member including a plurality of first clutch lugs, and
a second clutch member coupled for co-rotation with the output shaft, the second clutch member including a plurality of second clutch lugs,
wherein the plurality of first clutch lugs and the plurality of second clutch lugs oppose and engage one another when the output shaft rotates in the first direction.

14. The impact tool of claim 13, wherein the plurality of first clutch lugs are spaced apart in 90-degree increments, and wherein the plurality of second clutch lugs are spaced apart in 90-degree increments.

15. The impact tool of claim 13, wherein each of the plurality of first clutch lugs and the plurality of second clutch lugs each include a ramped surface oriented at an oblique angle relative to a rotational axis A of the output shaft.

16. The impact tool of claim 15, wherein the plurality of first clutch lugs and the plurality of second clutch lugs each include a step surface extending parallel to the rotational axis A.

17. The impact tool of claim 16, wherein the step surfaces of the plurality of first clutch lugs are engageable with the step surfaces of the plurality of second clutch lugs to couple the output shaft for co-rotation with the anvil in the first direction.

18. The impact tool of claim 16, wherein the ramped surfaces of the plurality of first clutch lugs are engageable with the ramped surfaces of the plurality of second clutch lugs to transfer torque from the first clutch member to the second clutch member in the second direction up to a torque setting of the clutch assembly.

19. The impact tool of claim 18, wherein the ramped surfaces of the plurality of first clutch lugs is configured to slide along the ramped surfaces of the plurality of second clutch lugs if resistance on the output shaft exceeds the torque setting of the clutch assembly.

20. The impact tool of claim 19, wherein the second clutch member is configured to translate along the axis away from the first clutch member in response to the first clutch member rotating relative to the second clutch member.
